(19) United States
(12) Patent Application Publication
(10) Pub. No.: US 2006/0045094 A1
(43) Pub. Date: Mar. 2, 2006

(54) Proportional fair scheduling apparatus for multi-transmission channel system, method thereof and recording medium for recording program of the same

(75) Inventors: Sang-Boh Yun, Seongnam-si (KR); Hoon Kim, Seoul (KR); Youngnam Han, Daejeon (KR); Keun-Young Kim, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/218,047

(22) Filed: Sep. 1, 2005

(30) Foreign Application Priority Data
Sep. 1, 2004 (KR) 69653/2004

(51) Int. Cl. H04L 12/56; H04L 12/28

(52) U.S. Cl. 370/395.4

(57) ABSTRACT

A proportional fair scheduling apparatus for a multi-transmission channel system, a method thereof and a recording medium for recording program of the same. When each user reports an available transmission rate of a current slot according to transmission channels in the multiple transmission channel system, the scheduling apparatus calculates an average transmission rate of previous slots, and calculates scheduling priority values for all allocation schemes of allocating each transmission channel to users according to transmission channels based on information about the transmission rates. The scheduling apparatus determines an allocation scheme having the maximum priority value from among the calculated priority values, and allocates the transmission channels to the users according to the result of the determination. Therefore, the proportional fair scheduling scheme is applied to the multiple transmission channel system, and the users can transmit signals in an optimum channel environment.

### PRIORITY

This application claims the benefit under 35 U.S.C. 119(a) of an application entitled “Proportional Fair Scheduling Apparatus For Multi-Transmission Channel System, Method Thereof And Recording Medium For Recording Program of the same” filed in the Korean Intellectual Property Office on Sep. 1, 2004 and assigned Serial No. 2004-69653, the entire contents of which are incorporated herein by reference.

### BACKGROUND OF THE INVENTION

1. Field of the Invention

The present invention relates generally to a proportional fair scheduling apparatus and method in a multi-transmission channel system, and a recording medium for recording a program the same, and more particularly to a proportional fair scheduling apparatus and method in a multi-transmission channel system capable of applying the proportional fair scheduling scheme proposed in the conventional single transmission-wave channel system to a multiple transmission-wave or multi-antenna system, and a recording medium for recording a program of the same.

2. Description of the Related Art

Recently, efficient management and use of radio resources have emerged as hot issues in a mobile communication system for providing multimedia services including high-speed data transmission.

Radio resource management technology includes a call admission control, a congestion control, dynamic channel allocation, handoff, a power control, a transmission-rate control, packet scheduling, a load sharing scheme, automatic repeat request (ARQ), etc.

A proportional fair scheduling scheme simultaneously considers system throughput and fair resource allocation to users in a radio channel environment, which is time-variant and differs depending on users, so the proportional fair scheduling scheme is used as a representative scheduling scheme of the radio resource management technology.

The proportional fair scheduling (P) is defined as shown in Equation (1).

$${\sum }_{i} \frac{{R}_{i}^{( S )} - {R}_{i}^{( P )}}{{R}_{i}^{( P )}} \leq 0 \qquad ( 1 )$$

In Equation (1), ‘Rᵢ^{(S)}’ represents an average transmission rate of user i obtained through scheduling ‘S’. As shown in Equation (1), the sum of rates of change in a transmission rate of each user, which may be calculated by any scheduling other than the proportional fair scheduling, is smaller than that by the proportional fair scheduling.

As described above, according to the proportional fair scheduling scheme, it is possible to efficiently perform scheduling by considering system throughput and resource allocation to users in a radio channel environment which is time-variant and differs depending on users.

A proportional fair scheduling in the conventional single transmission channel system is defined as shown in Equation (2), which is used in a high data rate (HDR) system called 1×Evolution-Data Optimized (1×EV-DO).

$$j = arg {max}_{i} \frac{{r}_{i}}{{R}_{i}^{′}} \qquad ( 2 )$$

In Equation (2), rᵢ represents an available transmission rate for a current slot of user i, and R′ᵢ represents an average transmission rate of previous scheduling slots. Referring to Equation. 2, priority is determined in proportion to the available transmission rate in view of increase of system throughput, and in inverse proportion to an average transmission rate of previous slots in view of fair resource allocation to users. However, since the proportional fair scheduling scheme proposed for the conventional single transmission channel system is designed to be basically applied to the single transmission channel environment, it is not applicable to a system using a multiple transmission-wave or multiple transmission antenna.

### SUMMARY OF THE INVENTION

Accordingly, the present invention has been designed to solve the above and other problems occurring in the prior art. An object of the present invention is to provide a proportional fair scheduling apparatus and method in a multi-transmission channel system, which can achieve the proportional fair scheduling regardless of transmission waves and the number of antennas in the next-generation mobile communication system, and a recording medium for recording a program the same.

To accomplish the above and other objects, according to the present invention, a proportional fair scheduling scheme applied to a single transmission-wave channel system is applied to a multiple transmission-wave or multi-antenna system.

In accordance with a first aspect of the present invention, there is provided a proportional fair scheduling apparatus in a multiple transmission channel system. The apparatus includes: a quality information display unit for outputting available transmission rates for transmission channels reported from each user, and an average transmission rate of previous slots calculated for each of users; and a maximum priority determination unit for calculating priority values with respect to allocation schemes of all combinations for allocating each transmission channel to users by using the available transmission rates of the transmission channels and the average transmission rate, and allocating transmission channels to users based on an allocation scheme having a maximum priority value from among calculated priority values.

In accordance with another aspect of the present invention, there is provided a proportional fair scheduling method in a multiple transmission channel system. The method includes the steps of: receiving an available transmission rate of a current slot according to transmission channels from each user; calculating an average transmission rate of previous slots according to each user; calculating priority values with respect to allocation schemes of all combinations for allocating each transmission channel to users by using the available transmission rate received and the average transmission rate calculated; and allocating transmission channels to users based on an allocation scheme having a maximum priority value from among the priority values calculated.

In accordance with another aspect of the present invention, there is provided a recording medium for recording a program of a proportional fair scheduling method for a multiple transmission channel system. The recording medium includes: a first function for receiving an available transmission rate of a current slot according to transmission channels from each user; a second function for calculating an average transmission rate of previous slots according to each user; a third function for calculating priority values with respect to allocation schemes of all combinations for allocating each transmission channel to users by using the available transmission rate received by the first function and the average transmission rate calculated by the second function; and a fourth function for allocating transmission channels to users based on an allocation scheme having a maximum priority value from among the priority values calculated by the third function.

### BRIEF DESCRIPTION OF THE DRAWINGS

The above and other objects, features, and advantages of the present invention will be more apparent from the following detailed description taken in conjunction with the accompanying drawings, in which:

FIG. 1 is a diagram schematically illustrating a multiple transmission channel system to which the present invention is applied;

FIG. 2 is a block diagram illustrating a proportional fair scheduling apparatus in a multiple transmission channel system according to an embodiment of the present invention;

FIG. 3 is a block diagram illustrating a maximum priority determination unit illustrated in FIG. 2; and

FIG. 4 is a graph illustrating average throughputs for each of users with respect to the proportional fair scheduling scheme according to an embodiment of the present invention and a conventional scheduling scheme.

### DETAILED DESCRIPTION OF THE PREFERRED EMBODIMENT

Preferred embodiments of the present invention will be described in detail herein below with reference to the accompanying drawings. In addition, the terminology used in the description is defined in consideration of the function of corresponding components used in the present invention and may be varied according to users' intentions or practices. Accordingly, the definition must be interpreted based on the overall content disclosed in the description.

Additionally, in the following description of the present invention, a detailed description of known functions and configurations incorporated herein will be omitted when it may obscure the subject matter of the present invention.

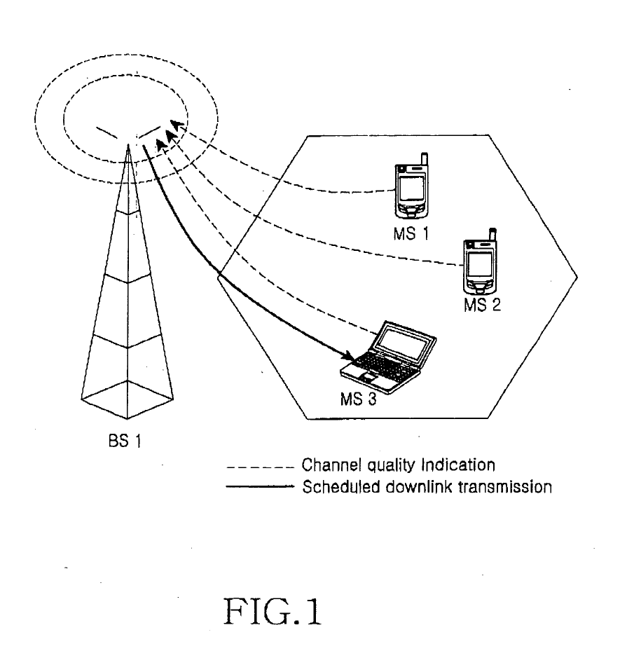

FIG. 1 is a diagram schematically illustrating a multiple transmission channel system to which the present invention is applied. Referring to FIG. 1, the multiple transmission channel system includes a base station (BS) and a plurality of mobile stations (MSs). The MSs report an available transmission rate for each of transmission channels to the base station. The base station allocates each transmission channel to a user in consideration of the channel information of each user and average transmission rate.

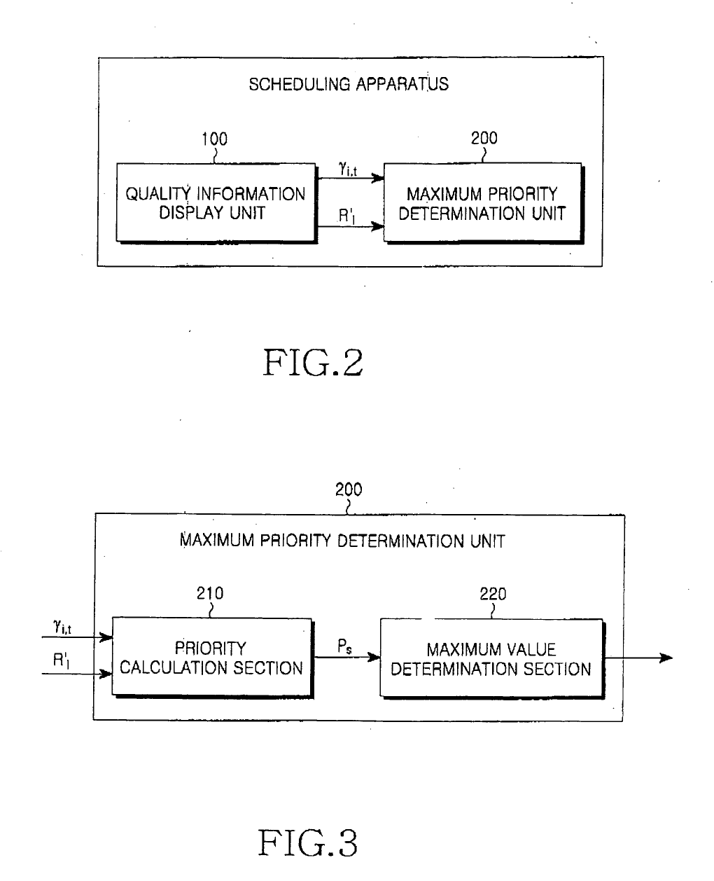

FIG. 2 is a block diagram illustrating a proportional fair scheduling apparatus in a multiple transmission channel system according to an embodiment of the present invention, and FIG. 3 is a block diagram illustrating a maximum priority determination unit illustrated in FIG. 2. Referring to FIG. 2, according to an embodiment of the present invention, the proportional fair scheduling apparatus in the multiple transmission channel system includes a quality information display unit 100 and a maximum priority determination unit 200. The quality information display unit 100 receives available transmission rates for the transmission channels from each user. In addition, the quality information display unit 100 transfers information about available transmission rates for transmission channels of each user and the average transmission rate of previous slots to the maximum priority determination unit 200. The average transmission rate of previous slots may be calculated by using previous available transmission rates for the transmission channels of each user.

The maximum priority determination unit 200 calculates priorities with respect to available allocation schemes for the transmission channels of each user, thereby determining an allocation scheme having the maximum priority value. The priorities may be obtained by using information about available transmission rates for the transmission channels of each user and the average transmission rate of previous slots.

Additionally, the maximum priority determination unit 200, as illustrated in FIG. 3, includes a priority calculation section 210 and a maximum value determination section 220. The priority calculation section 210 calculates priorities for available allocation schemes for the transmission channels of each user, and the maximum value determination section 220 determines the maximum priority based on the result of the calculation. It is noted, however, that the scope of the present invention is not to be limited by the above components.

In FIGS. 2 and 3, r_{i,c} represents the available transmission rate for a transmission channel c of user i in a current slot, R′ᵢ represents an average transmission rate of user i in a previous slot, and P_{S} represents a priority of allocation scheme S.

The quality information display unit 100 transfers an available transmission rate of a current slot according to each transmission channel, reported from each user, and an average transmission rate in previous slots to the maximum priority determination unit 200. The average transmission rate in the previous slots may be calculated by averaging transmission rates previously allocated for each of users.

The maximum priority determination unit 200 finds an allocation scheme having the maximum priority value from among allocation schemes of allocating each transmission channel to users according to transmission channels, thereby allocating each transmission channel to users according to the found allocation scheme.

More specifically, in the maximum priority determination unit 200, when a set of transmission channels is ‘C’, a set of users is ‘U’, and the number of elements included in set ‘(.)’ is expressed as ‘|(.)|’, the number of allocation schemes for allocating each transmission channel to users is expressed as |U|^{|C|}. In order to differentiate allocation schemes for the transmission channels, allocation scheme ‘S’ of transmission wave 1, transmission 2, . . . , transmission |C| to users c₁, c₂, . . . , c_{|C|}, respectively, is expressed as ‘S=(c₁, c₂, . . . , c_{|C|}). For example, when there are three transmission channels and three users, the number of allocation schemes becomes ‘27’. In this case, the allocation scheme of ‘S=(1,1,3)’ represents that transmission channels 1 and 2 are allocated to user 1, and transmission 3 is allocated to user 3.

The priority calculation section 210 calculates a scheduling priority value P_{S} for allocation scheme ‘S’ according to each transmission channel by using Equation 3.

$${P}_{S} = {\prod }_{i ∈ {U}_{S}} ( 1 + \frac{{\sum }_{k ∈ {C}_{i}} {r}_{i , k}}{( T - 1 ) {R}_{i}^{′}} ) \qquad ( 3 )$$

In Equation (3), U_{S} represents a set of users to which at least one transmission channel is allocated by ‘S’, and Cᵢ represents a set of transmission channels allocated to user i by ‘S’. T represents the number of slots used to obtain an average transmission rate.

For example, when an allocation scheme is expressed as ‘S=(1,1,3), U_{S}={1,3}, and U_{S,1}=1 and U_{S,2}=3. Accordingly, P_{S} is calculated as shown in Equation (4).

$$\begin{matrix}{P}_{S} = {\prod }_{i ∈ {U}_{S}} ( 1 + \frac{{\sum }_{k ∈ {C}_{i}} {r}_{i , k}}{( T - 1 ) {R}_{i}^{′}} ) = ( 1 + \frac{{\sum }_{k ∈ {C}_{i}} {r}_{1 , k}}{( T - 1 ) {R}_{1}^{′}} ) ( 1 + \frac{{\sum }_{k ∈ {C}_{i}} {r}_{3 , k}}{( T - 1 ) {R}_{3}^{′}} ) \\ = ( 1 + \frac{{r}_{1 , 1} {r}_{1 , 2}}{( T - 1 ) {R}_{1}^{′}} ) ( 1 + \frac{{r}_{3 , 3}}{( T - 1 ) {R}_{3}^{′}} )\end{matrix} \qquad ( 4 )$$

The maximum value determination section 220 finds an allocation scheme ‘J’ having the largest value, as shown in Equation (5), from among values of P_{S} calculated in the priority calculation section 210, and then allocates each transmission channel to users according to the found allocation scheme ‘J’.

For example, when J=(1,3,4), the maximum value determination section 220 allows users 1, 3 and 4, to use transmission channels 1, 2 and 3, respectively, for data transmission.

$$J = arg {max}_{S} {P}_{S} \qquad ( 5 )$$

Hereinafter, characteristics of the proportional fair scheduling provided by the proportional fair scheduling apparatus and method in the multiple transmission channel system according to an embodiment of the present invention will be described.

First, the characteristics of the proportional fair scheduling are expressed as shown in Equation (6).

$$P = arg {max}_{S} {\sum }_{i ∈ U} log {R}_{i}^{( S )} \qquad ( 6 )$$

That is, scheduling ‘S’ and proportional fair scheduling ‘P’ have a relation as shown in Equation (7), which may be replaced with a product set as shown in Equation (8).

$$\begin{matrix}{\sum }_{i ∈ U} log {R}_{i}^{( P )} \geq {\sum }_{i ∈ U} log {R}_{i}^{( S )} & ( 7 ) \\ {\prod }_{i ∈ U} {R}_{i}^{( P )} \geq {\prod }_{i ∈ U} {R}_{i}^{( S )} & ( 8 )\end{matrix}$$

Referring to Equations (7) and (8), for a user that is not selected by any one of scheduling ‘S’ and proportional fair scheduling ‘p, both sides of Equation (8) have the same value as shown in Equation (9). That is, an important user set is ‘U_{P}∪U_{S}’.

$${\prod }_{i ∈ {U}_{P} ⋃ {U}_{S}} {R}_{i}^{( P )} \geq {\prod }_{i ∈ {U}_{P} ⋃ {U}_{S}} {R}_{i}^{( S )} \qquad ( 9 )$$

Herein, U_{P}∪U_{S}=U_{P}∪(U_{S}−U_{P}) and U_{P}∪U_{S}=U_{S}∪(U_{P}−U_{S}) These relations are applied to Equation (8), thereby resulting in Equation (10).

$${\prod }_{i ∈ {U}_{P}} {R}_{i}^{( P )} {\prod }_{i ∈ {U}_{S} - {U}_{P}} {R}_{i}^{( P )} \geq {\prod }_{i ∈ {U}_{S}} {R}_{i}^{( S )} {\prod }_{i ∈ {U}_{P} - {U}_{S}} {R}_{i}^{( S )} \qquad ( 10 )$$

Herein, Rᵢ^{(S)} is an average transmission rate of a current slot, which may be expressed by means of R′ᵢ (average transmission rate of a previous slot), r_{i,c} (available transmission rate for transmission channel ‘c’ in a current slot), T (the number of slots to get an average transmission rate), etc., as shown in Equation (11).

$${R}_{i}^{( S )} = \frac{( T - 1 ) {R}_{i}^{′} + {I}_{\{ i ∈ {U}_{S} \}} {\sum }_{i ∈ {U}_{S}} {r}_{i , k}}{T} \qquad ( 11 )$$

The value of ‘I_{{iεU}_{_{S}}_{}}’ is 1 when {iεU_{S}} is true, but the value of ‘I_{{iεU}_{_{S}}_{}}’ is 0, which {iεU_{S}} is false. When Equation (11) is applied to Equation (10), the following Equation (12) is obtained.

$${\prod }_{i ∈ {U}_{P}} \frac{( T - 1 ) {R}_{i}^{′} + {\sum }_{i ∈ {U}_{P}} {r}_{i , k}}{T} {\prod }_{i ∈ {U}_{S} - {U}_{P}} \frac{( T - 1 ) {R}_{i}^{′}}{T} \geq {\prod }_{i ∈ {U}_{S}} \frac{( T - 1 ) {R}_{i}^{′} + {\sum }_{k ∈ {C}_{1}} {r}_{i , k}}{T} {\prod }_{i ∈ {U}_{P} - {U}_{S}} \frac{( T - 1 ) {R}_{i}^{′}}{T} \qquad ( 12 )$$

When both sides of Equation (12) are multiplied by

$${T}^{\vert {U}_{S} ⋃ {U}_{P} \vert} {\prod }_{i ∈ {U}_{S} ⋂ {U}_{P}} ( T - 1 ) {R}_{i}^{′} ,$$

the following Equation (13) is obtained.

$${\prod }_{i ∈ {U}_{P}} ( ( T - 1 ) {R}_{i}^{′} + {\sum }_{i ∈ {C}_{i}} {r}_{i , k} ) {\prod }_{i ∈ {U}_{S} - {U}_{P}} ( T - 1 ) {R}_{i}^{′} {\prod }_{i ∈ {U}_{S} ⋂ {U}_{P}} ( T - 1 ) {R}_{i}^{′} \geq {\prod }_{i ∈ {U}_{S}} ( ( T - 1 ) {R}_{i}^{′} + {\sum }_{i ∈ {C}_{i}} {r}_{i , k} ) {\prod }_{i ∈ {U}_{P} - {U}_{S}} ( T - 1 ) {R}_{i}^{′} {\prod }_{i ∈ {U}_{S} ⋂ {U}_{P}} ( T - 1 ) {R}_{i}^{′} \qquad ( 13 )$$

Equation (13) may be simplified as shown in Equation (14).

$${\prod }_{i ∈ {U}_{P}} ( ( T - 1 ) {R}_{i}^{′} + {\sum }_{i ∈ {C}_{i}} {r}_{i , k} ) {\prod }_{i ∈ {U}_{S}} ( T - 1 ) {R}_{i}^{′} \geq {\prod }_{i ∈ {U}_{S}} ( ( T - 1 ) {R}_{i}^{′} + {\sum }_{i ∈ {C}_{i}} {r}_{i , k} ) {\prod }_{i ∈ {U}_{P}} ( T - 1 ) {R}_{i}^{′} \qquad ( 14 )$$

Both sides of Equation (14) is divided by

$${\prod }_{i ∈ {U}_{S}} ( T - 1 ) {R}_{i}^{′} {\prod }_{i ∈ {U}_{P}} ( T - 1 ) {R}_{i}^{′} ,$$

Equation (15) is obtained.

$$\frac{{\prod }_{i ∈ {U}_{P}} ( T - 1 ) {R}_{i}^{′} + {\sum }_{i ∈ {C}_{i}} {r}_{i , k}}{{\prod }_{i ∈ {U}_{P}} ( T - 1 ) {R}_{i}^{′}} \geq \frac{{\prod }_{i ∈ {U}_{S}} ( T - 1 ) {R}_{i}^{′} + {\sum }_{i ∈ {C}_{i}} {r}_{i , k}}{{\prod }_{i ∈ {U}_{S}} ( T - 1 ) {R}_{i}^{′}} \qquad ( 15 )$$

Equation (15) is simplified as shown in Equation (16).

$${\prod }_{i ∈ {U}_{P}} \frac{( T - 1 ) {R}_{i}^{′} + {\sum }_{i ∈ {C}_{i}} {r}_{i , k}}{( T - 1 ) {R}_{i}^{′}} \geq {\prod }_{i ∈ {U}_{S}} \frac{( T - 1 ) {R}_{i}^{′} + {\sum }_{i ∈ {C}_{i}} {r}_{i , k}}{( T - 1 ) {R}_{i}^{′}} \qquad ( 16 )$$

Equation (16) may be expressed as Equation (17).

$${\prod }_{i ∈ {U}_{P}} ( 1 + \frac{{\sum }_{i ∈ {C}_{i}} {r}_{i , k}}{( T - 1 ) {R}_{i}^{′}} ) \geq {\prod }_{i ∈ {U}_{S}} ( 1 + \frac{{\sum }_{i ∈ {C}_{i}} {r}_{i , k}}{( T - 1 ) {R}_{i}^{′}} ) \qquad ( 17 )$$

Referring to Equation (17), it can be understood that a scheduling ‘S’ having the largest

$${\prod }_{i ∈ {U}_{S}} ( 1 + \frac{{\sum }_{i ∈ {C}_{i}} {r}_{i , k}}{( T - 1 ) {R}_{i}^{′}} )$$

value corresponds to the proportional fair scheduling.

As described above, according to the proportional fair scheduling apparatus and method of the present invention, it can be understood that the proportional fair scheduling scheme proposed in the single transmission-wave channel system can be applied to a multiple transmission-wave or multi-antenna system.

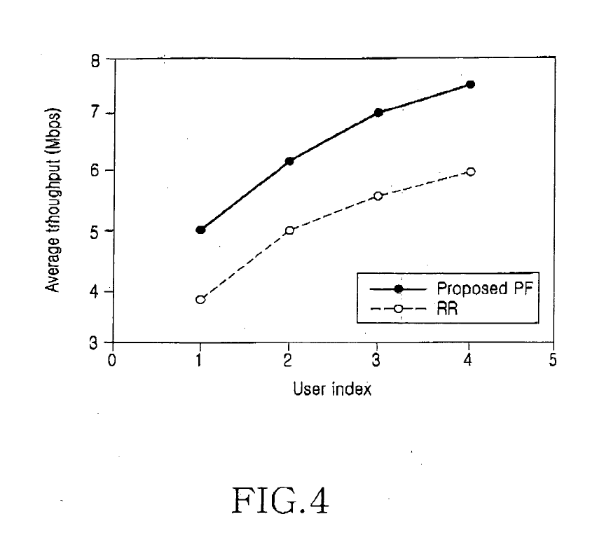

FIG. 4 is a graph illustrating average throughputs for each of users with respect to the proportional fair scheduling scheme according to an embodiment of the present invention and a conventional scheduling scheme. More specifically, FIG. 4 illustrates the performances of the proportional fair scheduling (Proposed PF) scheme according to an embodiment of the present invention and a round robin (RR) scheduling scheme for alternately allocating users at a scheduling point.

In FIG. 4, it is assumed that a transmission frequency is 2 GHz, the number of transmission channels is 4, the number of users is 4, a moving velocity is 100 km/h, and an interval between scheduling is 0.67 msec. In addition, a model of an available transmission rate of user i according to time is W log₂(1+SNRᵢ(t)), in which SNRᵢ(t)=i×bᵢ(t)(i=1,2, . . . ,10) and W is a frequency band of 1.25 MHz.

As illustrated in FIG. 4, a median SIR value increases in proportion to user index. ‘bᵢ(t)’ represents a power of Rayleigh Fading created by a Jakes model, and it is assumed to be independent between users.

Referring to FIG. 4, it can be understood that the throughputs of all users increases by 24% when the proportional fair scheduling scheme is used, as compared with those when the round robin (RR) scheduling scheme is used, because every user can transmit signals in a relatively superior channel environment through the proportional fair scheduling.

As described above, according to the present invention, the proportional fair scheduling apparatus and method can be applied in transmission technology using multiple transmission-waves or multi-antenna in the next-generation mobile communication system in the future.

Further, the proportional fair scheduling scheme in the multiple transmission-wave channel system according to an embodiment of the present invention can be realized by a program and can be stored in a recording medium (such as a CD ROM, a RAM, a floppy disk, a hard disk, an optical and magnetic disk, etc.) in a format that can be read by a computer.

As described above, according to the proportional fair scheduling apparatus for the multi-transmission channel system, the method thereof and the recording medium for recording program of the same, based on an embodiment of the present invention, the proportional fair scheduling scheme is applied to a multiple transmission-wave or multi-antenna system, such that every user can transmit signals in the optimum channel environment.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A proportional fair scheduling apparatus in a multiple transmission channel system, the apparatus comprising:
a quality information display unit for outputting available transmission rates for transmission channels reported from each of a plurality of users, and an average transmission rate of previous slots calculated for each of the plurality of users; and
a maximum priority determination unit for calculating priority values with respect to allocation schemes of all combinations for allocating each transmission channel to the plurality of users by using the available transmission rates of the transmission channels and the average transmission rate, and allocating transmission channels to the plurality of users based on an allocation scheme having a maximum priority value from among calculated priority values.

2. The apparatus as claimed in claim 1, wherein the maximum priority determination unit comprises:
a priority calculation section for calculating the priority values with respect to the allocation schemes of all the combinations for allocating each transmission channel to the plurality of users by using the available transmission rates of the transmission channels and the average transmission rate; and
a maximum value determination section for allocating transmission channels to the plurality of users based on the allocation scheme having the maximum priority value from among the priority values calculated by the priority calculation section.

3. The apparatus as claimed in claim 2, wherein the priority calculation section calculates a priority ‘P_{S}’ for each allocation scheme ‘S’ using:
$${P}_{S} = {\prod }_{i ∈ {U}_{S}} ( 1 + \frac{{\sum }_{k ∈ {C}_{i}} {r}_{i , k}}{( T - 1 ) {R}_{i}^{′}} ) ,$$
where U_{S} represents a set of users to which at least one transmission channel is allocated by allocation scheme ‘S’, r_{i,k} represents an available transmission rate for transmission channel k of user i in a current slot, R′ᵢ represents an average transmission rate of user i in a previous slot, Cᵢ represents a set of transmission channels allocated to user i by allocation scheme ‘S’, and T represents a number of slots used to obtain an average transmission rate.

4. The apparatus as claimed in claim 2, wherein the maximum priority determination unit determines an allocation scheme ‘J’ having the maximum priority value using
$$J = arg {max}_{S} {P}_{s} ,$$
where P_{S} represents a calculated priority for each allocation scheme ‘S’.

5. A proportional fair scheduling method in a multiple transmission channel system, the method comprising the steps of:
receiving an available transmission rate of a current slot according to transmission channels from each of a plurality of users;
calculating an average transmission rate of previous slots according to each of the plurality of users;
calculating priority values with respect to allocation schemes of all combinations for allocating each transmission channel to users by using the received available transmission rate and the calculated average transmission rate; and
allocating transmission channels to the plurality of users based on an allocation scheme having a maximum priority value from among the calculated priority values.

6. The method as claimed in claim 5, wherein the number of allocation schemes of all the combinations for allocating the transmission channels to users is calculated by:

|U|^{|C|},
wherein ‘C’ represents a set of transmission channels, ‘U’ represents a set of users, and each of |U| and |C| represents a number of elements included in a relevant set.

7. The method as claimed in claim 5, wherein scheduling priorities ‘P_{S}’ for all the available allocation schemes for the transmission channels of each of the plurality of users are calculated in a proportional fair scheduling scheme using:
$${P}_{S} = {\prod }_{i ∈ {U}_{S}} ( 1 + \frac{{\sum }_{k ∈ {C}_{i}} {r}_{i , k}}{( T - 1 ) {R}_{i}^{′}} ) ,$$
wherein, U_{S} represents a set of users to which at least one transmission channel is allocated by allocation scheme ‘S’, r_{i,k} represents an available transmission rate for transmission channel k of user i in a current slot, R′ᵢ represents an average transmission rate of user i in a previous slot, Cᵢ represents a set of transmission channels allocated to user i by allocation scheme ‘S’, and T represents a number of slots used to obtain an average transmission rate.

8. The method as claimed in claim 5, wherein an allocation scheme ‘J’ having the maximum priority value is determined by:
$$J = arg {max}_{S} {P}_{s} ,$$
where P_{S} represents a calculated priority for each allocation scheme ‘S’.

9. A recording medium for recording a program of a proportional fair scheduling method for a multiple transmission channel system, the recording medium comprising:
a first function for receiving an available transmission rate of a current slot according to transmission channels from each of a plurality of users;
a second function for calculating an average transmission rate of previous slots according to each of the plurality of users;
a third function for calculating priority values with respect to allocation schemes of all combinations for allocating each transmission channel to the users by using the available transmission rate received by the first function and the average transmission rate calculated by the second function; and
a fourth function for allocating transmission channels to the plurality of users based on an allocation scheme having a maximum priority value from among the priority values calculated by the third function.
